(19) United States
(12) Patent Application Publication
(10) Pub. No.: US 2023/0010892 A1
(43) Pub. Date: Jan. 12, 2023

(54) METHOD FOR IDENTIFYING AN EXTREME LOAD ON A WIND POWER INSTALLATION

(71) Applicant: Wobben Properties GmbH, Aurich (DE)

(72) Inventors: Stephan Vollack, Aurich (DE); Enno von Aswege, Großefehn (DE)

(21) Appl. No.: 17/860,028

(22) Filed: Jul. 7, 2022

(30) Foreign Application Priority Data
Jul. 8, 2021 (EP) 21184542.5

(51) Int. Cl. F03D 7/02

(52) U.S. Cl. CPC F03D 7/0224; F05B 2270/1095; F05B 2270/329; F05B 2270/331; F05B 2270/328

(57) ABSTRACT

The invention relates to a method for identifying an asymmetrical extreme load which is caused by a gust of wind and acts on a wind power installation, wherein the wind power installation has a rotor having at least three rotor blades; the rotor blades are adjustable in terms of the blade angle thereof; and the rotor by way of the rotor blades thereof sweeps a rotor field; and the method comprises continuous detecting of a blade load for each rotor blade; ascertaining for at least one sector of the rotor field at least one temporal sector load profile from blade loads detected of different rotor blades with the same azimuth position, said sector load profile describing a temporal profile of a load on the rotor blades in the sector and containing a profile extrapolated for a future temporal period, wherein the blade loads are detected or taken into account at successive detection time points which are spaced apart by a partial period in which the rotor rotates further by one rotor blade, so that successive blade loads are detected or taken into account for the respective sector; and checking in terms of expecting an extreme load as a function of the at least one sector load profile.

### BACKGROUND

### Technical Field

The present invention relates to a method for identifying an asymmetrical extreme load which is caused by a gust of wind and acts on a wind power installation. The present invention likewise relates to a method for controlling a wind power installation to reduce extreme loads. The invention also relates to a wind power installation for carrying out at least one of the two methods.

### Description of the Related Art

Wind power installations generate electric power from wind and are usually configured as so-called horizontal-axis wind power installations, each having an aerodynamic rotor having a plurality of, in particular three, rotor blades. During operation, these rotor blades sweep a rotor field when the aerodynamic rotor is in rotation. Such rotors in modern wind power installations have diameters of far beyond 100 m (meters), in some instances beyond 150 m. As a result, a high output can be generated from the wind, but high loads also arise. High extreme loads can briefly arise in particular when gusts of wind occur, said high extreme loads moreover potentially arising only locally in the large rotor field. Asymmetrical loads can be created as a result, which may form an additional load on the wind power installation.

In order for such loads of the wind power installation to be reduced, the wind speed and/or the load on the rotor blades can be continuously monitored. When an excessive load on the aerodynamic rotor, or the rotor blades, respectively, is identified in the process, the rotor blades in terms of the angle of attack thereof can be rotated out of the wind somewhat so as to consequently reduce the load, or to prevent a further increase in the load, respectively.

However, the issue that the high load that has already arisen on the aerodynamic rotor has led to corresponding flexing of the tower of the wind power installation may arise here. Using words to visualize this: the tower is pushed rearward to some extent, or is deflected toward the rear. As a result of the reduced load being introduced, the pressure acting on the aerodynamic rotor is also decreased so that the wind power installation swings back, at least in the region of the tower head. This in turn is a load on the tower that is likewise to be avoided.

In order to identify such loads at an early stage, measuring apparatuses for detecting the wind speed, which can detect the wind speed at a certain spacing from the aerodynamic rotor, can also be used. An approaching gust of wind can be identified as a result. Such an early warning system can be implemented by a so-called LiDAR measurement system. Such LiDAR systems can however be costly and can be error-prone in the event of unfavorable air conditions, in particular in the event of heavily polluted air, including air mixed with heavy rain.

### BRIEF SUMMARY

One or more embodiments are directed to identifying, avoiding, and/or reducing an asymmetrical extreme load caused by a gust of wind is to be proposed in particular. At least, an alternative solution to solutions known to date is to be proposed.

Provided is a method that relates to identifying an asymmetrical extreme load which is caused by a gust of wind and acts on a wind power installation. An extreme load is a load that exceeds a predeterminable load limit. An asymmetrical extreme load here is a load above a particular threshold value and that does not act uniformly on the rotor of the wind power installation but only in a punctiform manner, thus only in a sub-region of the rotor field.

The wind power installation has a rotor having at least three rotor blades, wherein the rotor blades are adjustable in terms of the blade angle thereof, and the rotor by way of the rotor blades thereof sweeps a rotor field.

The method comprises continuous detecting of a blade load for each rotor blade. The detection of the blade load can in particular take place continuously or at least quasi-continuously. The detection here can also be carried out at predetermined temporal intervals, for example, the latter however to be so small that a blade load is detected at least three times per revolution at the nominal rotating speed of the rotor. Preferably however, the blade load is to be detected substantially more frequently, in particular at least ten times or at least twenty times per revolution of the rotor. The detection of the blade load preferably takes place at least at every 60° of a rotor revolution, in particular at least at every 30° of a rotor revolution.

The blade load can in particular be detected in that a load is detected, for example by means of a strain gauge, on a blade root of each rotor blade, or at the rotor blade close to the blade root, in particular on the rotor blade at a maximum spacing of 10 m from the blade root.

It is furthermore proposed that for at least one sector of the rotor field at least one temporal sector load profile is ascertained from blade loads detected of different rotor blades with the same azimuth position. Such a sector load profile describes a temporal profile of a load of the rotor blades in the sector and contains a profile extrapolated for a future temporal period. In this way, for the at least one sector a blade load of that rotor blade that is situated in the sector is recorded. The rotor correspondingly rotates further so that after some time another rotor blade makes its way into the region of the observed sector, and the blade load is then detected for this rotor blade and is included in the sector load profile of this sector.

These two blade loads may already represent a temporal profile. This temporal profile can be extrapolated over time, for example by a linear regression. For example, should the blade load of a first rotor blade in the observed sector at the first time point be 40% of a reference blade load, and the blade load of the next rotor blade at the next time point be 50% of the reference blade load, 60% of the reference blade load can be assumed as extrapolated value for a third time point and thus also a third rotor blade. The profile from the second to the third time point is thus the extrapolated profile of the sector load profile.

The rotation of the rotor here is referred to as the rotation in the azimuth direction, and the positions of the rotor blades in terms of this rotation in the azimuth direction are accordingly referred to as azimuth positions.

For ascertaining a temporal sector load profile it is proposed here that the blade loads are detected or taken into account at successive detection time points which are spaced apart by a partial period in which the rotor rotates further by one rotor blade, so that successive blade loads are detected or taken into account for the respective sector. A blade load for a respective sector is thus always detected when a rotor blade is situated in the corresponding position, and the next detection takes place when the next rotor blade by virtue of the rotation of the rotor is situated in the corresponding position of the sector. To this end however, the blade loads can also be detected continuously or quasi-continuously, wherein the blade loads in this instance are in each case assigned to successive sectors. In this way, a plurality of measurements per sector can also be carried out and, for example, averaged so as to detect a blade load for the respective sector. As a result, successive blade loads can be detected for each sector, specifically a plurality of blade loads per revolution.

It has been recognized in particular that, by this detecting or taking into account at the detection time points, loads of the different rotor blades can however be assigned to the same sector. There is thus no need to wait for a complete revolution of the rotor.

This procedure is of course preferably carried out not only for one sector but for many sectors. For example, the rotor field can be divided into 12 equal sectors such that each sector has, by way of example, a size of 30°. A sector load profile is then ascertained for each of these 12 sectors, and to this end dedicated corresponding successive detection time points can be provided for each sector.

Detecting or taking into account at these successive detection time points can, of course, also be implemented such that absolute azimuth positions of the rotor are taken into account, and the blade loads are always detected or taken into account at the same positions. In the case of a uniform rotation of the rotor at a constant rotating speed, the partial period is in each case fixed. Said partial period assumes another value at another rotating speed, and the partial period can also correspondingly vary in the event of an acceleration or deceleration of the rotor, or of the rotor rotating speed, respectively.

It is now furthermore proposed that checking in terms of expecting an extreme load as a function of the at least one sector load profile takes place. In the simplest case, an extreme load is to be expected when the extrapolated profile of a sector load profile reaches or exceeds a load limit. When the wind power installation in this instance continues to operate without change, it is to be expected that this extreme load will then actually arise and in particular act on a rotor blade. In the event that the rotation continues, the extreme load can then also act on a further rotor blade.

However, it is proposed that such an extreme load to be expected is identified with the aid of the sector load profile and then countermeasures are in particular resorted to in order for the load to be reduced. This includes in particular the adjustment of the angles of attack of the rotor blades, or at least of the angle of attack of the rotor blade that is the next to reach the sector for which an extreme load is expected by virtue of the check.

In this context, sector load profiles are preferably recorded for each sector and evaluated in this context. It is thus continually checked for each sector load profile and thus for each sector whether an extreme load is to be expected in the respective sector. Each sector load profile is thus checked as to whether the latter reaches or exceeds a load limit.

However, the checking in terms of expecting an extreme load does not have to take place, or not only take place, by comparing the sector load profile with a load limit. Other checks may be added, for example as to what extent such a load limit is exceeded, or how fast the load changes, thus how steep the sector load profile is.

Moreover, a more complex extrapolation may be provided, for example in which not only a linear function, but a function of higher order is used for the extrapolation. To this end it can be provided in particular that more than only two blade loads successively detected for one sector are utilized for the extrapolation.

According to one aspect it is proposed that the sector load profile is configured as a temporal polynomial function of the first or higher order. Already described to this end was the use of a straight line, the latter thus being a temporal polynomial function of the first order, thus a straight line which may also have a gradient. In the case of a higher order, a quadratic polynomial function as a function of time may be assumed, for example.

Additionally or alternatively it is proposed that an extreme load to be expected is assumed when the sector load profile for a future time point reaches or exceeds a predetermined load limit. Such a future time point is in particular a time point which from the current time point is spaced apart by the partial period. The current time point can in particular be the time point at which the blade load for the observed sector was last detected. The future time point to this extent is in particular that time point at which the next rotor blade will reach the observed sector.

However, it is also conceivable for the future time point to be chosen in a different manner, in particular for said future time point to be chosen to be even further in the future, for example so as to be spaced apart from the current time point by two partial periods. Of course, the further in the future the future time point is chosen to be, the earlier an extreme load to be expected would be able to be identified; but such an expectation would also be more unreliable by the same measure.

According to one aspect it is proposed that the sector load profile is ascertained from at least two successive blade loads of a sector and at least one associated temporal period, and it is checked whether the sector load profile for a next successive detection time point, which is still in the future, reaches or exceeds the predetermined blade load limit. With the aid of two successive blade loads of the same sector and the associated partial period it is in particular possible to also determine a temporal gradient of the sector load profile, and the blade load to be expected for the next detection time point of the same sector can be determined while assuming a constant gradient.

To this extent, a prediction of the blade load for this next detection time point is carried out. Using the sector load profile thus ascertained, thus also using the thus predicted value of the blade load for the next detection time point, a comparison with the predetermined blade load limit can be carried out. As a result, it can be identified in advance whether an extreme load is to be expected. An extreme load is assumed in this instance when the predetermined blade load limit is reached or exceeded.

According to one aspect it is proposed that a blade load to be expected is ascertained by means of the sector load profile for a successive detection time point to be checked, the current blade load is detected at the successive detection time point to be checked and is compared with the blade load to be expected so as to ascertain an expectation variance. The sector load profile is then adapted as a function of the ascertained expectation variance.

The expected profile, the latter thus having been pre-calculated, is thus compared with the profile that has actually occurred. The variance at this successive detection time point to be checked may form the ascertained expectation variance. The sector load profile can be adapted as a function thereof. This here is in particular a prediction for the next detection time point that follows the currently checked detection time point. By way of the expectation variance it can be established, for example, that the blade load of the observed sector increases faster than predicted by the sector load profile. As a result, it can be identified in this instance that the blade load limit can be reached faster than expected.

The adapting of the sector load profile can take place in particular in that the sector load profile is changed from a linear profile to a curved profile, or is elevated in terms of the order thereof in another way. Or else the sector load profile may be enhanced by an additive component. In this way, for example, a sector load profile configured so as to be a straight line with a gradient can be supplemented by a straight line with a higher gradient. It is also conceivable for the parameters of the sector load profile to be adapted in a simple manner. If the sector load profile is thus defined so as to be a straight line with a gradient, this gradient can be correspondingly changed. If the sector load profile is a polynomial function of the second or higher order, specifically as a function of time, a plurality of parameters can be adapted in an analogous manner.

According to one aspect it is proposed that the blade loads of a rotor blade that has a blade root are in each case detected, in particular in each case as blade flexing or blade bending moment, on the rotor blade in the region of the blade root. It has been recognized in particular here that the entire load acting on the rotor blade acts on the blade root, or in the region of the blade root, respectively. Such a blade load can in particular be detected by one or a plurality of strain gauges in the region.

Such a blade load is ideally recorded directly at the blade root. The blade root can often however be made from metal, or at least transition to a metallic connection region for connecting to the rotor hub, while the rotor blade otherwise is made from another material, in particular from glass-fiber-reinforced plastics material. In order to avoid corresponding measuring inaccuracies which may arise in particular as a result of said transition region between two materials, a minor spacing of the measurement transducer on the rotor blade from the blade root, in particular from the connection flange, can be provided. The inner 10% of the rotor blade are understood to be in the region of the blade root. These thus are the first 10% from a blade connection adapter of the rotor blade to a rotor blade tip of the rotor blade. Flexing which can readily be detected and reflects substantially the entire load of the rotor blade can arise here.

To this end, bending sensors, in particular strain gauges, can be disposed in the region of the blade root on the rotor blade, said strain gauges moreover being distributed in the circumferential direction about a rotor blade longitudinal axis. In this case, at least two bending sensors, thus in particular strain gauges, should at least be disposed so as to be distributed by 90° in the circumferential direction about the rotor blade longitudinal axis. This here is based on the concept that the blade load to be detected may also have a direction. This direction depends in particular, but not only, on the respectively adjusted blade angle. The direction of the respective blade load can be detected by the bending sensors thus distributed, and the amplitude of the blade load can thus also be correctly detected overall.

According to one aspect it is proposed that a plurality of sectors of the rotor field are observed for extreme loads, and the blade loads for each observed sector are detected at the successive detection time points, specifically so that successive blade loads are detected for each sector and at least one change in the blade loads of the respective sector is ascertained therefrom. To this end it is furthermore proposed that a conclusion pertaining to a change to be expected in the blade loads of a second sector is drawn from the at least one change in the blade loads of a first sector. This takes place in particular so that the sector load profile of the second sector is adapted as a function of the sector load profile of the first sector.

It is provided that asymmetrical extreme loads are detected, so that it is expected that the blade loads of the sectors are dissimilar. Nevertheless, it has been recognized that an increase, in particular a high increase, in a blade load in one sector also permits conclusions to be drawn pertaining to an analogous increase of a blade load in another sector, in particular in a neighboring sector. It is thus proposed to conjointly take into account findings of one sector, derived from the sector load profile thereof, for another sector, specifically in particular for the sector load profile of the latter. The sector load profile of the second sector can be adapted by the sector load profile of the first sector, in particular when the first sector in the rotating direction of the rotor is disposed ahead of the second sector.

However, other constellations are also to be considered. It has been recognized in particular that in general an increase in a blade load at one position of the rotor field, in particular an increased increase of such a blade load, permits conclusions to be drawn pertaining to an increase of the blade loads in the entire rotor field. In other words, the absolute blade loads of one sector cannot be determined directly from those of another sector, but a scenario in which the wind speed and thus the blade load increases may apply to the entire rotor field or at least to a region of the rotor field that spreads across a plurality of sectors.

Additionally or alternatively, drawing the conclusion from the at least one change in the blade loads of the first sector in terms of the change to be expected in the blade loads of the second sector can take place so that a first sector load profile is determined for the first sector, and a second sector load profile is determined for the second sector.

A first expectation variance is ascertained for the first sector load profile, and the second sector load profile is adapted as a function of the first expectation variance. Here too, an expectation variance which is however not used, or not only used, for improving the sector load profile of the same sector but is used for improving the sector load profile of another sector is thus ascertained. As a result, an extreme load to be expected in a sector can be identified even earlier.

According to one aspect it is proposed that an extreme load time point at which an extreme load is expected to arise is determined. It is proposed in particular that the extreme load time point is determined from the at least one sector load profile. It is thus proposed to check when an extreme load arises, or is to be expected, respectively. As a function thereof, the wind power installation controller can make corresponding arrangements.

One potential arrangement lies in adjusting the rotor blades, or at least one rotor blade, in a correspondingly early manner, so as to, as a result, mitigate the extreme load expected. It has been recognized here in particular that, by taking such an early measure, it is avoided that the blade load, and thus also the thrust on the rotor blade and thus on the rotor, is not reduced only once the wind power installation by way of the tower head thereof has already been pushed heavily toward the rear. If the load is reduced only at that point, the consequence may be that the tower head swings back toward the front, which in turn may lead to tower loads which are to be avoided. This tower load can be avoided, or at least reduced, by reducing the blade load at an early stage.

According to one aspect it is proposed that the blade angles of the rotor blades are adjustable in a mutually independent manner.

As a result of the blade angles of the rotor blades being adjustable in a mutually independent manner, the blade loads can be individually influenced. By identifying specific loads at an early stage by way of the method proposed, the independent adjustment, thus the individual adjustment, of the blade angles can also be used in a targeted manner. It has also been recognized that an individual blade adjustment may represent a high load, in particular for the adjustment drives. However, by identifying at an early stage the blade load to be expected it can be achieved that the adjustment can be initiated in a timely fashion, as a result of which a lower adjustment speed is made possible, this minimizing the load.

Additionally or alternatively it is proposed that the blade angle of the respective rotor blade is taken into account for ascertaining a sector load profile for each blade load detected. It is proposed in particular that each blade load detected is converted into an equivalent blade load as a function of the associated blade angle which corresponds to a blade load at a predetermined reference blade angle.

It has been recognized in particular here that the blade angle has a great influence on the blade load, this being able to be correspondingly taken into account already when ascertaining the sector load profile. It has also been recognized here that an individual blade adjustment in which the rotor blades can assume dissimilar blade angles in a mutually independent manner may be present for the wind power installation. At the same prevailing wind this can lead to dissimilar blade loads resulting for different rotor blades in the same sector. It is proposed that this is taken into account and in particular eliminated by calculation.

Dissimilar blade angles in the same sector may also result for different blades in the same sector in the case of a synchronous adjustment of the blade angles of all rotor blades, because the rotor blades are in the same sector at different times.

Each sector load profile should reflect a load of the respective sector, independently of the specific rotor blade which is currently subject to such a load. In order to nevertheless obtain a uniform profile, it is proposed that each blade load detected is converted into an equivalent blade load. The equivalent blade load in this instance indicates the blade load which would arise if the rotor blade had the predetermined reference blade angle. The reference blade angle thus achieves a uniform reference variable so that blade loads which have been recorded at dissimilar blade angles are rendered more comparable.

On top of this, the sector load profile also contains a profile extrapolated for a future temporal period. When the blade load is in each case correlated with a reference blade angle, this extrapolation can be readily performed without having to in each case know the blade angle of the associated rotor blade at the extrapolated temporal period. On top of this, the sector load profile can be configured as a continuous profile, despite a blade load in the associated sector actually always being able to be present only when a rotor blade is also present in the sector. In this way, temporal ranges between two time points would be non-defined in terms of the rotor blade angle because no rotor blade is present in the sector in this instance. The dependence on the blade angle is therefore quasi eliminated from this calculation by referring to the reference blade angle, and the issue of indeterminacy mentioned is thus rendered obsolete.

A partial-load blade angle is particularly preferably used as the predetermined reference blade angle, said partial-load blade angle having been established and being used as the aerodynamically optimum blade angle for the partial-load range, or partial-load operation, respectively.

For this purpose, in particular a wind power installation which is controlled such that a fixedly adjusted blade angle is used for all rotor blades in the partial-load range is used as the basis. The partial-load range, or partial-load operation, respectively, is the one in which the prevailing wind speed has not yet reached a nominal wind speed and/or the wind power installation, without having been artificially throttled, is still operated below the nominal rotating speed, below the nominal output and/or below the nominal moment.

In the case of such a rotor blade angle, a maximum blade load has to be reckoned with in comparison to other blade angles. When the sector load profile is correlated with this blade angle, the sector load profile thus also reflects the profile of the maximum load. Accordingly, the maximum load can be evaluated and a blade angle having a lower blade load can be adjusted or predefined, respectively, as a function thereof, specifically when said maximum load exceeds the predetermined blade load limit. The wind power installation, or individual rotor blades, respectively, can eventually already be operated at a blade angle other than the predetermined reference blade angle.

A minimum blade angle which is not to be undershot can preferably be determined from an evaluation of a sector load profile. If the blade angle is smaller, the latter in this instance is adjusted to this predefined minimum blade angle. However, if the current blade angle is larger, or of identical size, no adjustment has to be performed. This here is based on a customary definition of the blade angles, in which the latter reach the maximum value thereof toward a feathered position, thus reach the maximum value thereof when said blade angles are completely rotated out of the wind. In a corresponding manner, the partial-load blade angle mentioned is a small angle. The partial-load blade angle can be in the range from −5° to 10°, in particular in the range from 0° to 5°, while the blade angle in the feathered position lies in the range from 80° to 110°, in particular in the range from approximately 90° to 100°.

According to one aspect it is proposed that each blade load detected as a function of the associated blade angle is converted into a local wind value, wherein it is provided in particular that a wind field is established from the wind values of some or all sectors. Additionally or alternatively it is proposed that each sector load profile is converted into a wind profile in the sector so that each wind profile contains a profile extrapolated for a future temporal period. It is provided in particular that a wind field profile is established from the wind profiles of some or all sectors.

The blade load detected is based on a specific wind situation and the latter can thus also be derived from the blade load detected. To this end, correlations between the blade load detected and the wind situation in a measurement installation having additional complex wind sensors, in particular LiDAR, can be detected, for example. A conclusion pertaining to wind values and the wind field can then be drawn from the loads based on these correlations, which may be recorded in advance, in the running operation. The wind field thus describes the distribution of the wind values across the sectors of the rotor field. Correlations between the blade load detected and the wind situation can also be determined by simulations, for example by using the blade element method (BEM).

Such a wind situation for the respective sector, apart from an average wind strength, can also contain a wind direction. A wind value can thus be formed as a pair of values composed of the wind speed and the wind direction. If the wind directions differ from one sector to the next, wind shear can also be derived therefrom. Said wind shear can likewise be part of the wind value. Wind directions and shear can be derived from variations of the blade load from one sector to the next. For example, a wind direction could be derived from two different load values, one of said load values reflecting a bending moment and the other a twisting moment of the same blade.

Moreover, a wind profile of the respective sector, thus a temporal change of the wind value of the respective sector, can be derived from the sector load profiles. Here too, changes of the wind direction can be part of such a wind profile. Wind shear can also be derived therefrom, in particular while furthermore taking into account the wind profiles of further, in particular neighboring, sectors.

It has thus been recognized that wind profiles can be derived from the sector load profiles, and said wind profiles overall can be taken into account as a wind field and herein as a wind field profile. The sector load profiles on which this is based also contain extrapolated profiles, and the wind profiles and thus the wind field profile can likewise contain an extrapolated range. A prediction of the wind field in the rotor field is possible in this way.

However, it is also possible for a wind field to be established only from the wind values of some or all sectors. It is thus not absolutely necessary to establish a wind field profile with a prediction, but establishing an actual state can also already be expedient.

According to one aspect it is proposed that when identifying an extreme load to be expected an installation operation in at least one sector is changed so as to reduce or delimit a load on the wind power installation. It is proposed in particular that the installation operation is changed in that the blade angle of at least one of the rotor blades is adjusted so as to reduce or delimit a blade load on the at least one rotor blade. In this way it is proposed to use the identification of an extreme load to be expected so that measures for reducing the load by changing the operation of the wind power installation are taken in a timely fashion. It is proposed in particular that the rotor blades, or at least one, is rotated out of the wind in a timely fashion. Effects to this end have already been described above.

It is proposed in particular that, when an extreme load time point at which the extreme load is to be expected has been identified, the installation operation is changed before the extreme load time point is reached. As a result, it can not only be prevented that the extreme load arises, but it can also be prevented that an overreaction takes place when changing the operation of the wind power installation, specifically when a response takes place only once the extreme load has arisen.

Additionally or alternatively it is proposed that a sector in which the extreme load is expected is identified, and the blade angle of a rotor blade is changed before said rotor blade reaches the sector for which the extreme load is expected. Proposed here in particular is thus an individual blade adjustment which in a targeted manner adjusts only the respective rotor blade for load reduction, so as to avoid the expected extreme load precisely in the localized sector. The wind power installation can otherwise continue to operate in a normal manner, and a blade adjustment does in particular not have to be performed, or not performed to the same extent, in other regions of the rotor field, so that as much energy as possible can continue to be generated therein.

Additionally or alternatively it is proposed that the blade angles of all rotor blades are adjusted. It is proposed in particular that this takes place prior to the time point at which the extreme load is expected, and that a reduction again takes place when the loads have been reduced again. In principle however, it is also conceivable for all rotor blades to be simultaneously adjusted when one rotor blade approaches the sector in which the extreme load is currently expected.

According to one aspect it is proposed that an adjustment angle for adjusting at least one rotor blade is determined from the at least one ascertained sector load profile, and/or a target time point until which the adjustment angle is to be adjusted is determined, and an adjustment speed is in particular determined and predefined from the target time point and the adjustment angle, and/or a minimum blade angle to be adjusted is determined, a rotor blade in terms of the blade angle thereof not being adjusted below said minimum blade angle to be adjusted.

In this way it is provided in particular that it is derived from the sector load profile not only whether a blade adjustment takes place but that the latter is also established according to size. A blade angle here can be derived directly from the sector load profile and be adjusted, wherein a blade angle profile may also be considered. Such a blade angle profile can follow the profile of the sector load profile, or be chosen so that the adjustment of the blade angle starts at an early stage so that said blade angle reaches a desired terminal value in a timely fashion.

It cannot only be identified at an early stage from the sector load profile when an adjustment is advisable, but also how said adjustment should best be carried out. The load profile indicates when a maximum load can be achieved and also how high said maximum load would be. The target time point at which the blade adjustment should be completed and which blade angle that sufficiently reduces the load to be expected is to be achieved can be derived therefrom. The adjustment angle results therefrom. The adjustment speed can be determined and predefined by way of an adjustment time to be adhered to, thus the duration until the target time point. Each rotor blade can thus be adjusted to the new position by way of an adapted adjustment speed.

The greatest load is to be expected at a minor blade angle, particularly at a partial-load blade angle as has already been explained above. For destressing, or for avoiding high loads, respectively, a rotor blade is thus rotated out of the wind, meaning that the blade angle of said rotor blade is enlarged. A minimum blade angle to be adjusted is thus a lower limit for the blade angle to be adjusted, and thus an upper load limit. It may arise that the blade angle is already larger than such a minimum blade angle to be adjusted; in this instance, no reduction in the blade angle should take place proceeding from an extreme load to be expected, the latter being derived from at least one sector load profile, because the current load would even be increased in this instance.

Proposed according to one aspect is a method for controlling a wind power installation, wherein the wind power installation is controlled as a function of identifying an asymmetrical extreme load which is caused by a gust of wind and acts on a wind power installation, and wherein the method for controlling carries out at least one method for identifying an asymmetrical extreme load caused by a gust of wind, according to one of the preceding aspects. The control method is thus based on the identification method. The wind power installation is controlled as a function of identifying the extreme loads.

To the extent that the method for identifying an asymmetrical extreme load caused by a gust of wind also comprises steps or features for controlling, or other steps or features, these steps or features are likewise to be incorporated by the method for controlling.

Also provided is a wind power installation, prepared for
carrying out a method for identifying an asymmetrical extreme load which is caused by a gust of wind and acts on the wind power installation; and/or
carrying out a method for controlling the wind power installation, wherein the wind power installation is controlled as a function of identifying an asymmetrical extreme load which is caused by a gust of wind and acts on a wind power installation;

wherein the wind power installation
has a rotor having at least three rotor blades;
the rotor blades are adjustable in terms of the blade angles thereof; and
the rotor with the rotor blades thereof sweeps a rotor field;

and the method comprises
continuous detecting of a blade load for each rotor blade;
ascertaining for at least one sector of the rotor field at least one temporal sector load profile from detected blade loads of different rotor blades with the same azimuth position, said sector load profile describing a temporal profile of a load on the rotor blades in the sector and containing a profile extrapolated for a future temporal period; wherein
the blade loads are detected or taken into account at successive detection time points which are spaced apart by a partial period in which the rotor rotates further by one rotor blade, so that successive blade loads are detected or taken into account for the respective sector; and
checking in terms of expecting an extreme load as a function of the at least one sector load profile.

Such a method for controlling the wind power installation is implemented in particular in the wind power installation, in particular in a computer processor or a controller computer or other control device. A detection device is provided for detecting a blade load for each rotor blade. Said detection device can comprise, for example, strain gauges on the rotor blades, and at least one evaluation device for evaluating corresponding signals received from the strain gauges.

The wind power installation is in particular prepared for carrying out a method according to one of the aspects described above. The wind power installation has in particular a control device for carrying out a control method, and the control method here is implemented in the control device. To this end, the control device can have a computer processor in which the method is implemented. However, the control device can also have a plurality of units among which the method is allocated.

The control device preferably comprises a controller for controlling the wind power installation and a detection unit, such as a sensor, for detecting an extreme load.

### BRIEF DESCRIPTION OF THE SEVERAL VIEWS OF THE DRAWINGS

The invention will be explained in more detail below in an exemplary manner by means of embodiments and with reference to the appended figures in which:

FIG. 1 shows a wind power installation in a perspective illustration;

FIG. 2 shows a temporal diagram for visualizing one aspect;

FIG. 3 shows a front view of a rotor field;

FIG. 4 shows a schematic lateral view of a wind power installation and thus also of a rotor field shown in FIG. 3;

FIGS. 5 and 6 each show a front view of a rotor field at different rotor positions; and

FIG. 7 shows a temporal diagram for visualizing an improvement of the prognosis.

### DETAILED DESCRIPTION

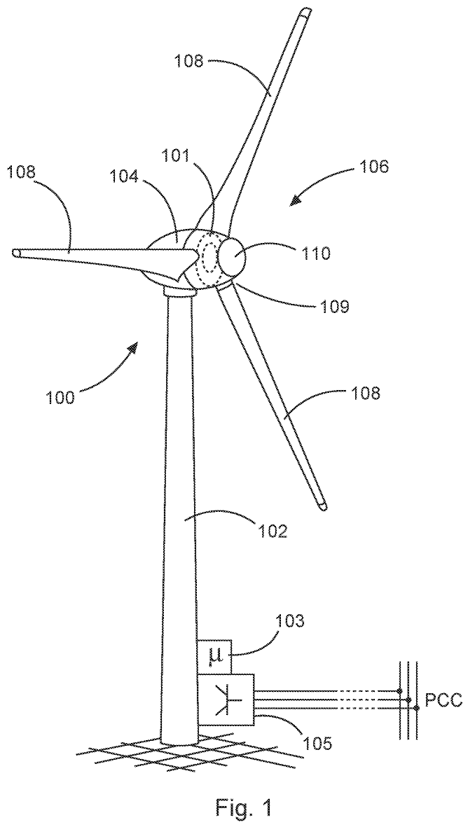

FIG. 1 shows a schematic illustration of a wind power installation according to the invention. The wind power installation 100 has a tower 102 and a nacelle 104 on the tower 102. An aerodynamic rotor 106 having three rotor blades 108 and a spinner 110 is provided on the nacelle 104. The aerodynamic rotor 106 in the operation of the wind power installation is set in a rotating motion by the wind and thus also rotates an electrodynamic rotor of a generator which is coupled directly or indirectly to the aerodynamic rotor 106. The electric generator is disposed in the nacelle 104 and generates electric power. The pitch angles of the rotor blades 108 can be changed by pitch motors at the rotor blade roots 109 of the respective rotor blades 108.

The wind power installation 100 here has an electric generator 101 which is indicated in the nacelle 104. An electric output can be generated by means of the generator 101. An infeed unit 105, which can in particular be configured as an inverter, is provided for infeeding electric output. In this way, a three-phase feed current and/or a three-phase feed voltage can be generated according to amplitude, frequency and phase, in order to be fed to a mains connection point PCC. This may take place directly or else conjointly with further wind power installations in a wind farm. An installation controller 103 is provided for controlling the wind power installation 100 and also the infeed unit 105. The installation controller 103 may also receive parameter values from outside, in particular from a central farm computer.

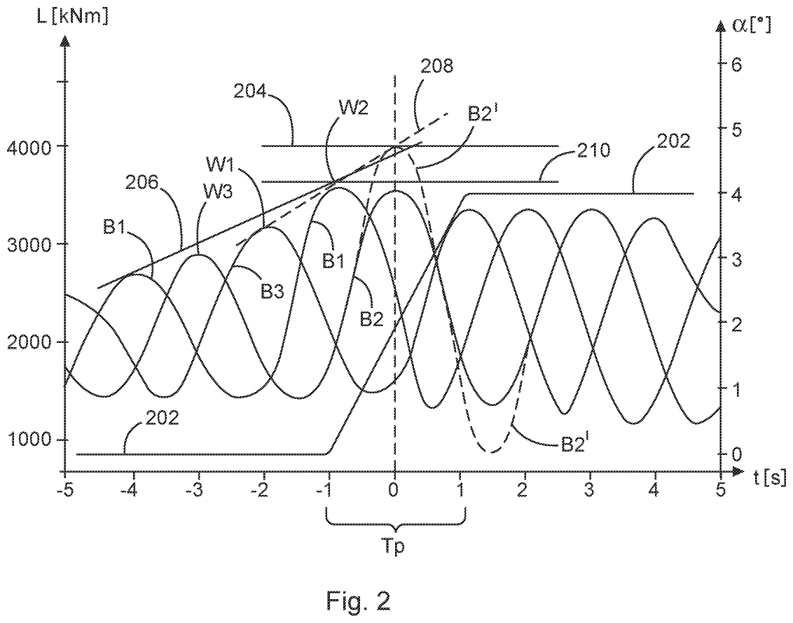

FIG. 2 shows a temporal diagram in which for three rotor blades an exemplary load profile of an equivalent blade load is illustrated, the latter thus being converted into a reference angle, thus standardized. These load profiles, which synonymously may also be referred to as blade load profiles, are referred to as B1, B2 and B3 in FIG. 2, thus as load profiles for a first, second and third rotor blade.

Moreover plotted is a blade angle profile 202. The blade angles can be adjusted in a mutually independent manner, this forming the basis here too, but the variances between the blades are not relevant in terms of the general explanation according to FIG. 2 so that, for the sake of simplicity, only this single blade angle profile 202 is shown in this FIG. 2.

The temporal diagram on the abscissa thus shows the time in seconds, on the left ordinate shows the load in Kilonewton meters, and on the right ordinate shows the blade angle in degrees. The temporal zero point is chosen where a load profile would have reached a limit, specifically the permissible maximum value, had the blade angle not been changed. Plotted to this end is a non-optimal blade load profile B2′ which at t=0 reaches an extreme load value 204 and reflects a profile without blade angle adjustment.

Starting approximately 5 s (seconds) ahead of this zero point, the three load profiles B1-B3 are burdened with variations but increase in terms of the amplitude. Previously, said load profiles B1-B3 were burdened with similar variations but did not increase, this not being illustrated here. The variations in the load of these three load profiles B1-B3 can also be traced back to, inter alia, the fact that the rotor blades as a result of the rotation of the rotor sweep different regions in the rotor field and, as a result, are exposed to dissimilar wind loads. The loads can be lower in particular in the lower region and higher in the upper region. To be added to this, however, are wind variations or other variations in the wind field. Moreover, the profiles are illustrated in a simplified manner, because further comparatively minor variations are not relevant here.

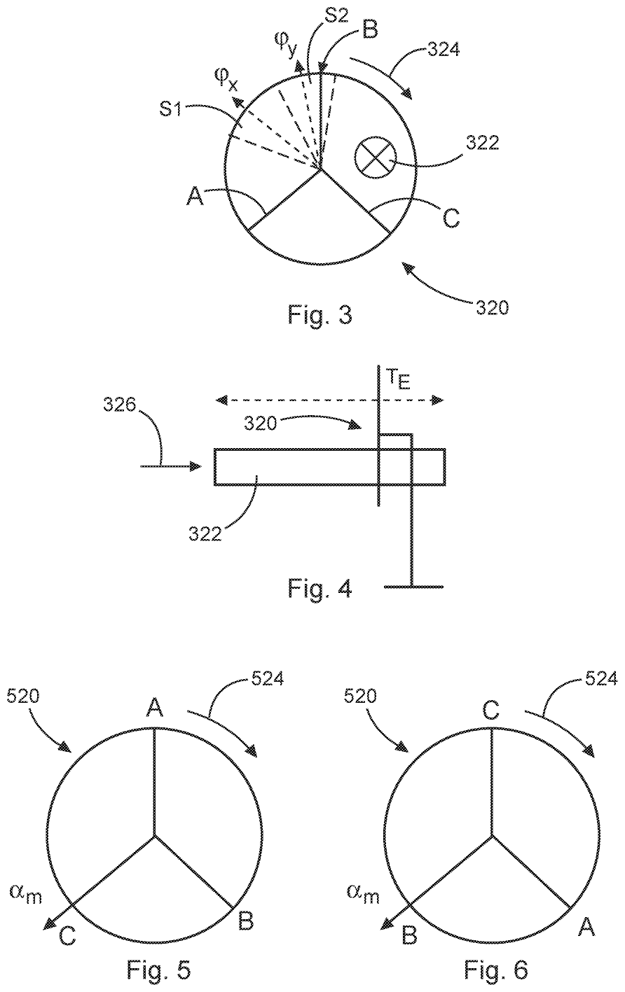

The temporal diagram of FIG. 2 is based on an operation of the wind power installation in which the rotor rotates at approximately 20 rpm (rotations-per-minute). In this way, the rotor rotates further by one rotor blade in approximately 1 s. Approximately every 1 s, this results in a type of load peak for respectively alternating blades. The rotor blades in the process sweep a wind range from which a high load emanates. This will also be explained in particular hereunder in FIGS. 3 and 4.

Moreover, the extreme load value 204 in the temporal diagram according to FIG. 2 is plotted as a horizontal straight line. This load illustrated should ideally not be reached, at least not exceeded.

Proceeding from the initially weak load it can be seen that this load increases. In order to now prevent that the extreme load value 204 is reached, a corresponding check can be carried out. The loads illustrated can be detected, for example, by strain gauges at the blade root, or close to the blade root, respectively, and compared with a limit such as the extreme load value 204.

However, this has the disadvantage that such a detection and such a comparison takes place at a very late stage. Alternatively, a comparison with a reduced limit could be carried out so as to trigger a countermeasure, specifically a blade adjustment, at an earlier stage. However, this could lead to undesirable triggering when the extreme load value 204 is not reached at all, but such a reduced limit is achieved only once.

Instead it is proposed that the increase to be seen in FIG. 2 is evaluated so as to anticipate that the extreme load value 204 is reached as is to be expected.

Such a load increase can be identified, for example proceeding from the observation of only one blade load profile, for example of the first blade load profile B1.

To this end, an individual linear increase 206 by way of example is plotted as a solid straight line, the latter being configured fundamentally as a connection between the two maximum values of the first blade load profile B1. Such an individual linear load 206 however has the disadvantage that the latter may be inaccurate and/or requires at least one revolution of the rotor in order to be able to be recorded in the first place.

Proposed instead is a sector load profile 208 which therein is plotted as a long-dashed straight line. The sector load profile 208 here is configured as straight line and is determined from two values of the two blade load profiles B1 and B3. The two load values used to this end are plotted as the first and the second load value W1 and W2. This sector load profile 208 can be determined from these two values which in the example shown are only 1 second apart, and it can be seen that the load in the sector would very soon reach the maximum value.

This sector load profile 208 can be calculated at the moment at which the second load value W2 is reached, and it can be identified that the extreme load value 204 will soon be reached. At this time point, here thus one second prior to reaching the extreme load value 204, pitching is thus initiated. The blade angle of all blades is enlarged, the rotor blades thus being rotated out of the wind. The blade angle profile 202 shows this.

As a result of the blade angle, or the blade angles, respectively, being adjusted at an early stage, a moderate adjustment speed is possible, the latter here by way of example being 2° per second (2°/s). However, said adjustment speed may also be lower and be 1°/s, for example. In the example shown, the blade angle in the first second upon starting the adjustment has thus been changed by 2°. This already leads to the load profile B2 of the second blade no longer reaching the extreme load value 204. After two seconds, the blade angle is then adjusted by 4°, this leading to significant destressing. The blade angle can then also be, at least somewhat, reduced again. Solely for the purpose of visualization, said blade angle in the illustration of FIG. 2 as from 1 s assumes the constant value of 4°.

The following is proposed in particular. At the time point of triggering a blade adjustment, the momentary load on the blades, a pitch angle and the load to be expected are known, or can at least be estimated. On this basis, an angle can be predicted so that a resultant terminal angle is known. As a result, the pitch speed can be correspondingly predefined, and the deployment can take place slowly or rapidly, depending on the situation. The pitch speed, thus the speed at which the rotor blades are adjusted, can thus be predefined and controlled in a targeted manner.

Alternatively, this sector load profile 208 can also consider the load values of all three blade load profiles B1-B3, in that the blade load profile B2 is additionally considered as the third load value W3, for example. The sector load profile 208 in this instance would have a somewhat different profile. Said sector load profile 208 could likewise be a straight line, or else be configured as a curve of the second order, thus be described as a polynomial of the second order as a function of time.

The load values W1 to W3 can in each case be mean values of a plurality of measured values of the respective blade in the respective sector, for example. The sector load profile 208 does not have to be a tangent of the two blade load profiles B1 and B3, or of all three load profiles, respectively. However, the load values W1 to W3 are situated in the range of the maximum values of the blade load profiles, because this is where the sector with the maximum load lies. Sectors with a lower load are also examined but here do not lead to the blade adjustment being triggered. Therefore, the evaluation of said sectors with a lower load is not illustrated here.

The rotor field can be divided into 36 sectors of in each case 10°, to name one example, and in each of these 36 sectors such a sector load profile 208 is recorded, for example. In this instance, this also results in sector load profiles which may lie in the range of the lower values, for example, but then do not lead to a high load being identified.

In the example of 36 sectors, this thus results in 36 sector load profiles, and the most critical thereof is considered for minimizing the load, the most critical being the one with a tendency toward reaching the extreme load value 204. The sector load profile 208 is such a critical sector and is thus also situated approximately at the load peaks of the three blade load profiles B1-B3.

By using all rotor blades, thus the load values of all rotor blades of a respective sector, the sector load profile 208 can be constructed at an early stage so as to be a straight line based on two load values, thus on in each case one load value of two rotor blades, for example. However, it is also conceivable for a plurality of values, thus three values, for example, to be recorded, as has already been described above. As a result, it is still always possible for the blade load profile to be determined before the rotor has carried out a complete revolution. Nevertheless, three values are already present, the latter moreover also making it possible for the sector load profile 208 to be embodied not only as a straight line but also as a curve. When using three load values, a curve of the second order, thus able to be described by a polynomial of the second order, can be used. However, it is also conceivable for a straight line to be used nevertheless, said straight line being fundamentally overdetermined by evaluating three values, this however making it possible to compensate for inaccuracies in the values. The result can thus become more accurate.

It is also conceivable for even more values to be recorded. When four values are recorded, this then however requiring a revolution of the rotor, a straight line can continue to be used as the sector load profile 208, said straight line being even more overdetermined and inaccuracies thus being able to be better compensated for. However, it is also conceivable for a curve of the second order to be used, the latter still being overdetermined and inaccuracies thus being able to be compensated for. If required, it is of course also conceivable for a curve of an even higher order to be used.

The preferred variant is to reproduce sector load profiles by a curve of the first or the second order.

The evaluation of such a sector load profile 208 can take place in that it is checked whether the sector load profile 208 reaches the extreme load value 204 within a predetermined checking period T_{P}. This checking period T_{P} in FIG. 2 is approximately 2 s (seconds). However, the current value of the sector load profile, thus also the current load, has only just reached a reduced extreme load value 210. The detection is thus very early so that the measure, i.e., the adjustment of the rotor blades, leads to only the reduced extreme load value 210 being reached. This checking period T_{P} can also be chosen as a function of the adjustment speed of the blade adjustment.

FIG. 3 shows a rotor field 320 in a front view, in which three rotor blades A-C are likewise schematically indicated. Moreover plotted is a wind event 322 which drives an extreme load, thus a gust of wind, for example. This wind event 322 is present in a specific region of the rotor field 320 and thus in a specific sector. The wind event 322 may also impact a plurality of sectors.

A rotor rotation 324 is likewise schematically indicated by a corresponding arrow. However, the position of the wind event 322 does not change as a result of the rotation of the rotor, and as a result every successive rotor blade will reach this wind event as long as the latter is present.

Illustrated in an exemplary manner in FIG. 3 are two sectors S1 and S2 which can in each case be represented by a mean angle φₓ and φ_{y}, respectively. The rotor blade B is currently situated in the sector S2. It can be detected how long one rotor blade or two rotor blades requires/require in order for this angle to be swept. A load increase speed can also be derived therefrom.

The situation in FIG. 3 is illustrated in a lateral view in FIG. 4. The wind event 322 in a simplifying manner is illustrated as a cylinder which moves in the direction toward the rotor field 320. This is indicated by the event movement 326. It can thus be seen that the wind event 322 arises only in a temporally limited manner. This is indicated by the period T_{E}, the latter thus visualizing the timescale of the wind event driving the extreme load.

FIGS. 5 and 6 visualize how the load situation can be managed, in particular how a sector load profile can be recorded. To this end, a sector approximately in the 8 o'clock position is observed in an exemplary manner in FIG. 5. Likewise illustrated in FIG. 5 is thus a rotor field 520 which has three rotor blades A, B and C. The rotor blade C is at the 8 o'clock position. At the latter, a current load is recorded by corresponding strain gauges at the blade root, or close to the blade root, respectively, for example. Moreover recorded is a measurement angle αₘ; the measurement angle αₘ is the current blade angle of the rotor blade C. Said current blade angle can be measured, or else be read or put to further use, respectively, from the control data of the wind power installation.

A standardized load for a specific angular value thus results as a function of the rotor blade angle and the detected load. The blade angle of 0°, or a partial-load angle, can in particular be used as the reference value here. Here too, the rotor continues to rotate according to the rotor rotation 524, and one position later is visualized in FIG. 6.

In FIG. 6, the rotor blade B is thus at the 8 o'clock position, and the load on the blade and the blade angle, visualized by the measurement angle αₘ, is recorded again at this position. Here, the load standardized for a reference angle can be calculated, and this then results in two values from which a sector load profile can already be determined. As a result of the standardization, different blade positions can be calculated, as it is possible that a blade adjustment has been carried out during the rotation of the rotor blade B from the 4 o'clock position to the 8 o'clock position. It is also possible for the rotor blades B and C to have different blade angles. However, in order to be able to make a statement pertaining to the respectively observed sector, in particular pertaining to the load profile, based on values of different rotor blades, this standardization preferably takes place so as to relate to a reference angle.

The procedure explained in an exemplary manner in the context of the 8 o'clock position takes place in a similar manner and also substantially simultaneously for all sectors into which the rotor and thus the rotor field 520 have been divided. Of course, a load value cannot be recorded exactly simultaneously for all sectors, because the rotor blades can of course only always be present in one sector at the same time. The corresponding values can thus be recorded simultaneously for three sectors.

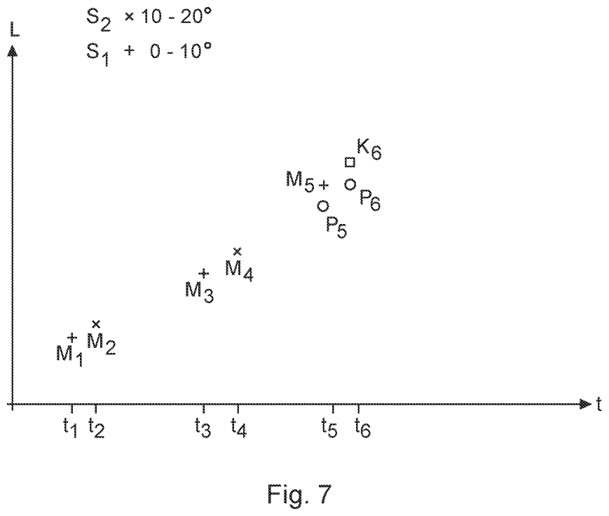

FIG. 7 shows a temporal diagram in which load measurements for two sectors are illustrated. The abscissa here shows a time axis and the ordinate shows a load which could, at least fundamentally, correspond to the left ordinate in FIG. 2. The improvement of prognosis is to be explained in principle in FIG. 7, so that specific load values are not plotted. FIG. 2 is very schematic also in other aspects. It is assumed here that, for just under one rotation, load values are in each case considered in two sectors.

Measurements in the sector S₁ are illustrated by +, and measurements in the sector S₂ by x. Accordingly, the first measurement for the first sector takes place at the time point t₁, the next measurement for the second sector takes place at the time point t₂. Another measurement in the first sector, specifically for the next blade, takes place at the time point t₃, and for the second sector, likewise for this next blade, takes place at the time point t₄. These measured values are identified as measured values M₁-M₄. In this way, a sector load profile, for example as a straight line, can be determined from the measured values M₁ and M₃ for the first sector. A load value for the time point t₅ can be predicted therefrom, said load value being plotted as P₅ in the diagram. A circle has been chosen as the symbol so as to highlight that this is not a measurement but a prognosis. A prognosis value P₆ for the second sector has likewise been determined for the time point t₆, specifically from the measured values M₂ and M₄.

Now, a further measurement M₅ is carried out at the time point t₅, and it is established for said further measurement M₅ that the latter lies above the prognosis value P₅. It can thus be derived that the wind speed increases, as opposed to the prognosis. This information can also be used for the second sector S₂. It can be derived therefrom that the prognosis P₆ is potentially too low. Accordingly, it can be derived for the more intense increase of the wind speed derived from the development of the first sector that this is also to be expected for the sector S₂. Accordingly, the prognosis P₆ can be escalated to the corrected prognosis K₆.

The invention thus describes a solution by way of which a sector load profile can be identified at an early stage. A load profile is thus identified by sectors, specifically based on values of each rotor blade which is situated in the sector at a measurement time point.

FIG. 2 in particular visualizes a so-called load control event which, while indeed being schematically illustrated therein, corresponds to an actual load recording. The illustration here is also intended to relate in principle that it can be seen that the loads on all blades already continuously increase and an early intervention by means of the blade angle is therefore possible.

The following assumptions have been made in particular here. It has been assumed that the loads increase over a characteristic time scale, the latter typically being a plurality of seconds long. It is furthermore assumed that a local asymmetrical wind speed increase which does not act across the entire rotor field prevails. This is to be visualized in particular by FIGS. 3 and 4. Therefore, the event illustrated may also be considered to be a shear event. A magnitude of the timescale is assumed in which each blade sweeps multiple times across the wind event, or the wind condition, driving the extreme load, respectively. Each blade thus sweeps multiple times across the corresponding sector or the corresponding sectors in which a wind event driving such an extreme load arises.

The following measures which are also to be explained in the figures are proposed in particular. A temporal profile of the blade bending moments of all blades is recorded. For example, strain gauges which are continually evaluated can thus be present.

The determination of a difference between two blade bending moments of two successive blades can take place, for example from blade C to blade B, as is explained in FIGS. 5 and 6. The load can be recorded as a function of the rotor position and a difference can be formed. In this case, two load values are thus recorded.

The influence of the blade angle is additionally taken into account when determining the blade flexing or blade load, and thus also when determining the difference between two blade bending moments. For this purpose, the blade angle of the leading blade can be taken into account, for example, or a general reference angle can be used as the basis. In any case, the influence of the blade angle is taken into account, and this can take place in that the blade angle difference between the two measuring time points, thus between the two rotor blades, is determined. This blade angle difference can be additionally taken into account in the difference between the two blade load values, thus between the two blade bending moments, because said blade angle difference causes a relative change in the blade bending moment, the latter being taken into account as a result.

An increase by means of which an extreme load to be expected at specific discrete temporal intervals is estimated is determined by means of these differences in terms of the blade angle as well as time.

The increase can be determined by a linear straight line, or else by a polynomial of a higher order. To this end, more than two values may optionally be recorded.

When a limit criterion is exceeded, a control action for enlarging the blade angle of one or all blades so as to minimize the extreme load to be expected is then triggered. The limit criterion can be formed from a combination of an extreme load limit, such as the extreme load value 204 of FIG. 2, and a temporal spacing from the current time point until a corresponding extreme load arises, thus until the extreme load limit is reached. In other words, the straight line, should the latter ascend in the first place, can indeed reach the limit criterion, thus the extreme load value 204, but should this be far in the future no measure must yet to be taken.

The resolution of the rotor field in terms of sectors can be chosen, for example so as to be 36 sectors of in each case 10°.

In this way it can be achieved that the blade angles can be adjusted by observing such a gradient at an early stage, as a result of which a low pitch speed can be chosen. Accordingly, besides reducing an extreme load on the blades, a gentler operation management can also be made possible. It can be achieved in particular as a result that peak loads in pitch motors are avoided, and the tower deflection in extreme scenarios is minimized.

The load for a third of a rotor revolution can in particular be extrapolated. Following a third of the rotor revolution, two values can be recorded, specifically for one blade and a following blade, and an extrapolation can be performed therefrom. The quality of the prognosis for each observed sector is thus known after 1/X rotor revolutions. It is currently assumed that X=3. The focus here is in particular on identifying the quality of the prognosis, or improving the prognosis, as is explained in FIG. 7.

While a third of the rotation is indeed required in order to rotate the rotor from one rotor blade to the next in one sector, an estimation of the quality of the prognosis is indeed possible before a further third of a rotor revolution takes place, whereby it would also be possible to wait for a third of a rotor revolution. It can already be identified when the rotor has moved somewhat onward whether a stronger or weaker increase in the wind is generally present. This finding can be applied to the prognoses already established, and the quality can be estimated in this way. Should the wind increase thus accelerate during this time, it can then be seen that a prognosis will be exceeded. This information can now be utilized for the following sectors in order for the prognosis to be corrected, as is explained in FIG. 7.

An improvement has in particular been achieved by the solution proposed. In a previous variant, which is now being improved, the pitch system reacts when an extreme load arises in a single blade and attempts to avoid any further increase of the load by very rapidly pitching out of position. As a result of such a brief reduction of the thrust absorbed by the rotor, the tower is heavily accelerated toward the front, this likewise leading to undesired extreme loads on the tower. The proposed solution however enables slower pitching, thus a slower adjustment of the rotor blades, this not resulting in a rapid decrease in thrust, and the tower thus not being heavily accelerated toward the front. Previously, the tower, proceeding from a heavy thrust previously received, would swing toward the front, so to speak. This is now avoided.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
identifying an asymmetrical extreme load caused by a gust of wind and acting on a wind power installation, wherein the wind power installation comprises:
a rotor having at least three rotor blades;
wherein the at least three rotor blades have adjustable blade angles; and
wherein the rotor, by way of the at least three rotor blades, sweeps a rotor field;
wherein the identifying comprises:
continuously detecting blade loads for each rotor blade;
ascertaining for at least one sector of the rotor field at least one temporal sector load profile from blade loads detected of different rotor blades of the at least three rotor blades with the same azimuth position, said sector load profile describing a temporal profile of a load on the respective rotor blade in the sector and containing a profile extrapolated for a future temporal period, wherein:
the blade loads are detected or taken into account at successive detection time points which are spaced apart by a partial period in which the rotor rotates further by one rotor blade, so that successive blade loads are detected or taken into account for the respective sector; and
checking in terms of expecting an asymmetrical extreme load as a function of the at least one sector load profile.

2. The method as claimed in claim 1, wherein:
the sector load profile is configured as a temporal polynomial function of a first or a higher order; and/or
the asymmetrical extreme load expected is assumed when the sector load profile for a future time point reaches or exceeds a predetermined blade load limit.

3. The method as claimed in claim 1, wherein:
the sector load profile is ascertained from at least two successive blade loads of a sector and at least one associated partial period; and
the method further comprising checking whether the sector load profile for a next successive detection time point, which is to occur in the future, reaches or exceeds a predetermined blade load limit, respectively.

4. The method as claimed in claim 1, comprising:
ascertaining a blade load to be expected by the sector load profile for a successive detection time point to be checked;
detecting the current blade load at the successive detection time point to be checked and comparing the current blade load with the blade load to be expected so as to ascertain an expectation variance; and
adapting the sector load profile as a function of the ascertained expectation variance.

5. The method as claimed in claim 1, wherein the blade loads of a first rotor blade of the at least three rotor blades are detected as blade flexing or blade bending moment in a region of a blade root of the first rotor blade.

6. The method as claimed in claim 1, wherein:
a plurality of sectors of the rotor field are observed for extreme loads;
the blade loads for each observed sector are detected at the successive detection time points, so that successive blade loads are detected for each sector and at least one change in the blade loads of the respective sector is ascertained therefrom; and
a conclusion pertaining to a change to be expected in the blade loads of a second sector is drawn from the at least one change in the blade loads of a first sector such that:
the sector load profile of the second sector is adapted as a function of the sector load profile of the first sector; and/or
a first sector load profile is determined for the first sector, and a second sector load profile is determined for the second sector;
a first expectation variance is ascertained for the first sector load profile; and
the second sector load profile is adapted as a function of the first expectation variance.

7. The method as claimed in claim 1 comprising:
determining an extreme load time point at which an extreme load is expected to arise, and
determining the extreme load time point from the at least one sector load profile.

8. The method as claimed in claim 1, wherein:
the blade angles of the at least three rotor blades are adjustable in a mutually independent manner; and/or
the respective blade angle of the respective rotor blade of the at least three rotor blades is taken into account for determining a sector load profile for each blade load detected.

9. The method as claimed in claim 8, wherein each blade load detected as a function of the associated blade angle is converted into an equivalent blade load which corresponds to a blade load at a predetermined reference blade angle.

10. The method as claimed in claim 1, wherein each blade load detected as a function of the associated blade angle is converted into a local wind value.

11. The method as claimed in claim 10, wherein the wind field is established from the wind values of at least some of the sectors; and/or
wherein each sector load profile is converted into a wind profile in the sector so that each wind profile contains a profile extrapolated for a future temporal period, and
wherein a wind field profile is established from the wind profiles of some or all sectors.

12. The method as claimed in claim 1, wherein when identifying the extreme load to be expected an installation operation in at least one sector is changed so as to reduce or delimit a load on the wind power installation, wherein the installation operation is changed in that the blade angle of at least one of the at least three rotor blades is adjusted so as to reduce or delimit a blade load on the at least one rotor blade.

13. The method as claimed in claim 12, comprising:
when an extreme load time point at which the extreme load is to be expected has been identified, the installation operation is changed before the extreme load time point is reached; and/or
wherein a sector in which the extreme load is expected is identified, and the blade angle of a rotor blade is changed before said rotor blade reaches the sector for which the extreme load is expected; and/or
wherein the blade angles of the at least three rotor blades are adjusted.

14. The method as claimed in claim 1, wherein:
from the at least one ascertained sector load profile an adjustment angle for adjusting at least one rotor blade is determined; and/or
a target time point until which the adjustment angle is to be adjusted is determined, and an adjustment speed is determined and predefined from the target time point and the adjustment angle; and/or
a minimum blade angle to be adjusted is determined, wherein a blade angle of at least one rotor blade is not adjusted below said minimum blade angle.

15. The method as claimed in claim 14, comprising:
controlling the wind power installation as a function of the asymmetrical extreme load.

16. A wind power installation, comprising:
a rotor;
at least three rotor blades coupled to the rotor, the at least three rotor blades having adjustable blade angles, wherein the rotor, by way of the at least three rotor blades, sweeps a rotor field,
a sensor configured to continuously sense blade loads acting on each rotor blade of the at least three rotor blades; and
a processor configured to receive the sensed loads and identify an asymmetrical extreme load caused by a gust of wind from the sensed loads; and
control the wind power installation as a function of the identified asymmetrical extreme load,
wherein identifying the asymmetrical extreme load comprises:
ascertaining for at least one sector of the rotor field at least one temporal sector load profile from blade loads detected of different rotor blades of the at least three rotor blades with the same azimuth position, said sector load profile describing a temporal profile of a load on the respective rotor blade in the sector and containing a profile extrapolated for a future temporal period;
wherein the blade loads are detected or taken into account at successive detection time points which are spaced apart by a partial period in which the rotor rotates further by one rotor blade, so that successive blade loads are detected or taken into account for the respective sector; and
wherein checking in terms of expecting an asymmetrical extreme load as a function of the at least one sector load profile.
